(19) United States
(12) Patent Application Publication
(10) Pub. No.: US 2025/0264123 A1
(43) Pub. Date: Aug. 21, 2025

(54) CUSTOMIZING APPARATUS

(71) Applicants: Hyundai Motor Company, Seoul (KR); Kia Corporation, Seoul (KR); SEOYON E-HWA CO., LTD., Anyang-si (KR)

(72) Inventors: Jin Ho HWANG, Cheonan-Si (KR); Ji Seob Park, Incheon (KR); Dong Eun Cha, Hwaseong-Si (KR); Sang Heon Lee, Seoul (KR); Dae Hyung Lee, Hwaseong-Si (KR); Hyeok Lee, Siheung-Si (KR)

(73) Assignees: Hyundai Motor Company, Seoul (KR); Kia Corporation, Seoul (KR); SEOYON E-HWA CO., LTD., Anyang-Si (KR)

(21) Appl. No.: 18/798,392

(22) Filed: Aug. 8, 2024

(30) Foreign Application Priority Data
Feb. 19, 2024 (KR) 10-2024-0023614

(51) Int. Cl. F16B 5/06

(52) U.S. Cl. CPC F16B 5/0664

(57) ABSTRACT

A customizing apparatus includes a wall portion forming an internal wall and an external wall of a mobility and including a predetermined area; a pocket portion provided in plural in the predetermined area of the wall portion, including a mounting hole formed on a center portion thereof, and including a plurality of locking protrusions along a periphery of the mounting hole; and a panel portion including a panel and a plurality of boss portions extending from the panel and configured to be inserted into the mounting hole, wherein the boss portions are positioned at a side of the locking protrusion when inserted into the mounting hole, and the boss portions are fixedly locked to the locking protrusion in a rotation direction when the panel is rotated.

### CROSS REFERENCE TO RELATED APPLICATION

The present application claims priority to Korean Patent Application No. 10-2024-0023614 filed on Feb. 19, 2024, the entire contents of which is incorporated herein for all purposes by this reference.

### BACKGROUND OF THE PRESENT DISCLOSURE

### Field of the Present Disclosure

The present disclosure relates to a customizing apparatus configured for changing design elements or functions according to customers' needs.

### Description of Related Art

Recently, a purpose built vehicle (PBV) is being developed as an electric vehicle-based ground transportation, and the PBV may be moved not by vehicle wheels but by electric wheels which move freely 360 degrees, provide customized services required while occupants move to destinations beyond a simple means of transportation, and reflect a personalized design to allow the occupant to move to various spaces from leisure spaces, such as restaurants, cafes, and hotels, to essential social facilities, such as hospitals and pharmacies, in addition to performing a city shuttle function. To the present end, an interior of a body may be customized by use of products modularized according to the purpose.

Therefore, various changes of internal spaces in design and function are required for various purposes. A design is determined at the time of initial production, and a large scale of work such as painting is required to change the design elements, making it difficult to freely change the design elements.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a customizing apparatus configured for variously changing design elements depending on a user's needs.

To achieve the object, a customizing apparatus according to an exemplary embodiment of the present disclosure includes a wall portion forming an internal wall and an external wall of a mobility and including a predetermined area, a pocket portion provided in plural in the predetermined area of the wall portion, including a mounting hole on a center portion of the pocket portion, and including a plurality of locking protrusions along a periphery of the mounting hole, and a panel portion including a panel and a plurality of boss portions extending from the panel and configured to be inserted into the mounting hole, wherein the boss portions are positioned at a side of the locking protrusion when inserted into the mounting hole, and the boss portions are fixedly locked to the locking protrusion in a rotation direction when the panel is rotated.

The pocket portion may include a plurality of locking protrusions spaced from each other at equal intervals in the mounting hole, and the boss portions may be disposed on the panel portion in the same number as and to be spaced from each other at a same interval as the locking protrusion.

The locking protrusion of the pocket portion may include a first support end portion extending toward the center portion of the mounting hole, and a second support end portion protruding from the first support end portion in a direction facing the panel portion.

The boss portion of the panel portion may include a first insertion end portion extending to be inserted into the mounting hole and formed to be curved, and a second insertion end portion connected to an extending end portion of the first insertion end portion to form a space together with the first insertion end portion.

A third insertion end portion inserted into the mounting hole and connected to a plurality of first insertion end portions may be formed on the panel portion.

A reinforcement rib connected to two or more of the first insertion end portion, the second insertion end portion, and the third insertion end portion may be formed on the panel portion.

The first insertion end portion extending in a direction which is inserted into the mounting hole may be formed to have a larger length than the second support end portion in a direction which faces the panel portion, and the second insertion end portion and the second support end portion may be spaced from each other at a predetermined interval.

An upper locking portion and a lower locking portion may be spaced from the mounting hole and formed on an upper portion and a lower portion of the pocket portion, respectively, and the panel portion may be formed with an upper fastening portion detachably fastened to an upper locking portion, and a lower fastening portion detachable fastened to a lower locking portion.

The upper locking portion may be formed with a first locking hole which protrudes to allow an upper portion of the panel portion to protrude to be accommodated and into which the upper fastening portion of the panel portion is locked by being inserted into the first locking hole.

The upper fastening portion may include a first seating portion protruding to be supported on an upper surface of the upper locking portion, and a first connection portion inserted to be locked to the first locking hole.

The lower locking portion may be formed with a second locking hole and protrudes to allow a lower portion of the panel portion to be accommodated on the lower locking portion and the lower fastening portion of the panel portion is locked by being inserted into the second locking hole.

The lower fastening portion may include a second seating portion protruding to be supported on a lower surface of the lower locking portion, and a second connection portion inserted to be locked to the second locking hole.

The upper locking portion and the upper fastening portion, and the lower locking portion and the lower fastening portion may be positioned to be fastened by being matched mutually in a state in which the boss portion of the panel portion is locked by being rotated after inserted into the mounting hole of the pocket portion.

When the panel portion is mounted on the pocket portion, the panel portion may be rotated in the state in which the boss portion of the panel portion is inserted into the mounting hole of the pocket portion so that the boss portion is locked to the locking protrusion, and the upper locking portion and the upper fastening portion, and the lower locking portion and the lower fastening portion may be fixed by being sequentially fastened therebetween.

When the panel portion is removed from the pocket portion, the boss portion may be switched to a removable state by rotating the panel portion after the upper fastening portion and the lower fastening portion of the panel portion are sequentially removed to allow the boss portion to be removed from the locking protrusion.

According to the customizing apparatus including the above configuration, it is possible to variously change the design elements according to the user's needs, save the design change cost, secure the convenience for installation and removal, and secure stability by securing collision rigidity.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing a wall portion of a mobility according to an exemplary embodiment of the present disclosure.

FIG. 2 is a view showing a pocket portion in the customizing apparatus according to an exemplary embodiment of the present disclosure.

FIG. 3 is a detailed view of the pocket portion shown in FIG. 1.

FIG. 4 is a view showing a panel portion in the customizing apparatus according to an exemplary embodiment of the present disclosure.

FIG. 5 is a view showing the customizing apparatus according to an exemplary embodiment of the present disclosure.

FIG. 6 is a cross-sectional view along line A-A′ upon mounting in the customizing apparatus shown in FIG. 5.

FIG. 7 is a cross-sectional view along line B-B′ upon mounting in the customizing apparatus shown in FIG. 5.

FIG. 8 is a cross-sectional view along line C-C′ upon mounting in the customizing apparatus shown in FIG. 5.

FIG. 9 is a cross-sectional view along line D-D′ upon mounting in the customizing apparatus shown in FIG. 5.

FIG. 10 is a cross-sectional view along line E-E′ upon mounting in the customizing apparatus shown in FIG. 5.

FIG. 11 is a cross-sectional view along line D-D′ upon removing in the customizing apparatus shown in FIG. 5.

FIG. 12 is a cross-sectional view along line E-E′ upon removing in the customizing apparatus shown in FIG. 5.

FIG. 13 is a cross-sectional view along line B-B′ upon removing in the customizing apparatus shown in FIG. 5.

FIG. 14 is a cross-sectional view along line C-C′ upon removing in the customizing apparatus shown in FIG. 5.

FIG. 15 is a cross-sectional view along line A-A′ upon removing in the customizing apparatus shown in FIG. 5.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings, and the same or similar components are denoted by the same reference numerals regardless of the drawing symbols, and overlapping descriptions thereof will be omitted.

The suffixes “module” and “unit” for components used in the following description are provided or used interchangeably in consideration of ease of preparing the specification and do not have meanings or roles that are distinct from each other by themselves.

In describing the exemplary embodiments included in the specification, when it is determined that a detailed description of a related known technology may obscure the gist of the exemplary embodiments included in the present specification, a detailed description thereof will be omitted. Furthermore, the accompanying drawings are only for easy understanding of the exemplary embodiments included in the specification, and it should be understood that the technical spirit included in the specification is not limited by the accompanying drawings, and all changes, equivalents, or substitutes included in the spirit and technical scope of the present disclosure are included in the accompanying drawings.

Terms including ordinal numbers such as first or second may be used to describe various components, but the components are not limited by the terms. The terms are used only for distinguishing one component from another.

When a first component is referred to as being “connected” or “coupled” to a second component, it should be understood that the first component may be directly connected or coupled to the second component or a third component may be present therebetween. On the other hand, when the first component is referred to as being “directly connected” or “directly coupled” to the second component, it should be understood that the third component is not present therebetween.

The singular expression includes the plural expression unless the context clearly dictates otherwise.

In the specification, it should be understood that the term “comprise” or “have” is intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Hereinafter, a customizing apparatus according to an exemplary embodiment of the present disclosure will be described with reference to the accompanying drawings.

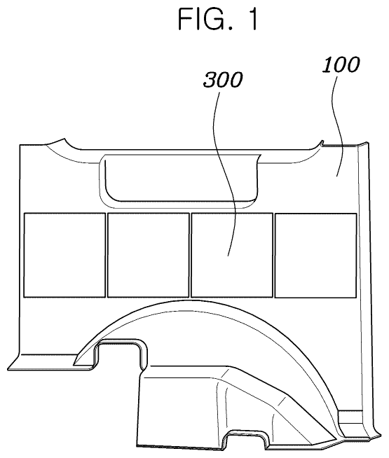

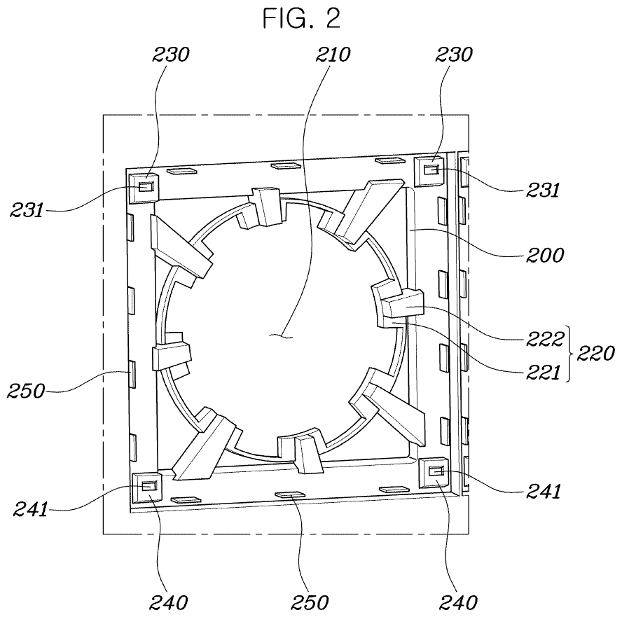

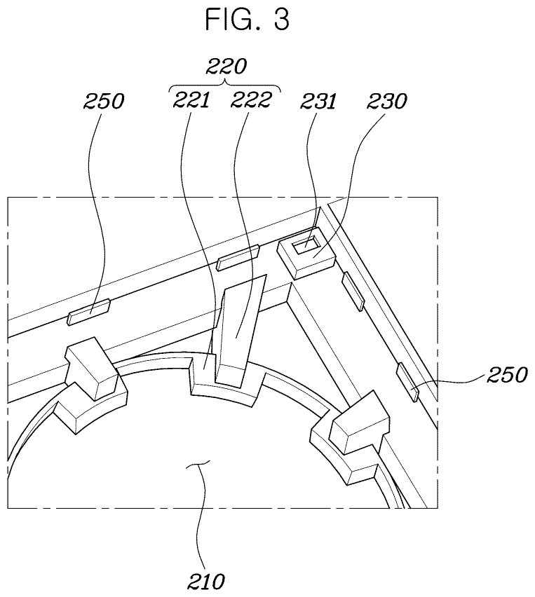

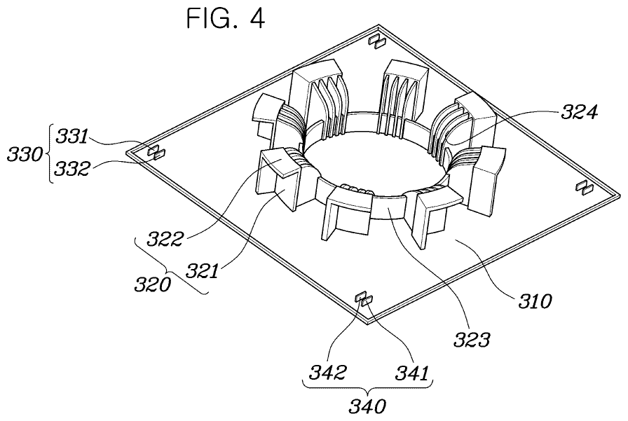

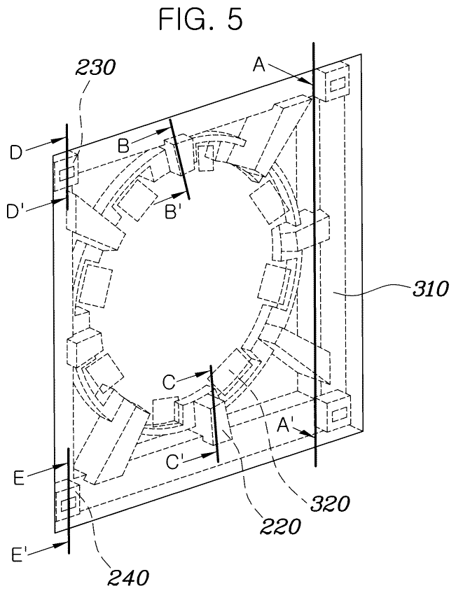

As shown in FIG. 1, FIG. 2, FIG. 3, FIG. 4, and FIG. 5, the customizing apparatus according to an exemplary embodiment of the present disclosure includes a wall portion 100 forming an internal wall or external wall of a mobility, a pocket portion 200 provided in plural in a predetermined area of the wall portion 100, including a mounting hole 210 formed on a center portion thereof, and formed with a plurality of locking protrusions 220 along a periphery of the mounting hole 210, and a panel portion 300 including a panel 310 and a plurality of boss portions 320 extending from the panel 310 and inserted into the mounting hole 210, in which the boss portion 320 is positioned at a side of the locking protrusion 220 when inserted into the mounting hole 210, and the boss portion 320 is fixedly locked to the locking protrusion 220 in a rotation direction when the panel 310 is rotated.

The wall portion 100 may become the internal wall or external wall of the mobility and in an exemplary embodiment of the present disclosure, include a predetermined area in an internal wall of an interior thereof. The predetermined area may be set variously depending on the use purpose or design elements of the mobility.

The predetermined area is provided with a plurality of pocket portions 200, and the panel portion 300 is mounted on each pocket portion 200.

The pocket portion 200 is formed in plural in the predetermined area of the wall portion 100 and includes the mounting hole 210 formed in a center portion thereof, and a plurality of locking protrusions 220 are formed along the periphery of the mounting hole 210.

The panel portion 300 is detachably mounted on the pocket portion 200. In other words, the pocket portion 200 includes the panel 310 and the boss portion 320, and the panel 310 is formed to cover the pocket portion 200. A material, color, and shape of the panel 310 may be changed variously depending on design elements and configured to adopt various functional elements in addition to a display function.

The boss portion 320 is formed on the panel 310 to be fixed to the pocket portion 200, and the boss portion 320 is configured in plural to match the plurality of locking protrusions 220 and configured to be locked to the locking protrusion 220 in the rotation direction in a state of being inserted into the mounting hole 210.

Therefore, the panel portion 300 may be mounted on or removed from the pocket portion 200 and mounted on the pocket portion 200 in a rotation manner to maintain the robust mounting state.

Specifically describing the present disclosure, the pocket portion 200 may include the plurality of locking protrusions 220 spaced from each other at equal intervals in the mounting hole 210 in a circumferential direction thereof, and the boss portions 320 may be disposed on the panel portion 300 in the same number as the plurality of locking protrusions 220 and to be spaced from each other at the same interval as the locking protrusion 220 in the circumferential direction.

As described above, the locking protrusion 220 of the pocket portion 200 and the boss portion 320 of the panel portion 300 may be formed in the same number, and the locking protrusions 220 and the boss portions 320 may be disposed to be spaced at equal intervals so that the panel portion 300 may be mounted on the pocket portion 200 with a uniform fastening strength.

As shown in FIGS. 2 and 4, the locking protrusions 220 and the boss portions 320 may be spaced at 45° intervals in a circumferential direction of the mounting hole 210, and the numbers and intervals of locking protrusions 220 and boss portions 320 may be set according to the fastening rigidity required when the panel portion 300 is mounted on the pocket portion 200.

Meanwhile, as shown in FIG. 2 and FIG. 3, the locking protrusion 220 of the pocket portion 200 may include a first support end portion 221 extending toward the center portion of the mounting hole 210, and a second support end portion 222 protruding from the first support end portion 221 in a direction facing the panel portion 300.

The locking protrusion 220 includes the first support end portion 221 and the second support end portion 222, in which the first support end portion 221 is formed to extend toward the center portion of the mounting hole 210, and the second support end portion 222 is formed to protrude from the first support end portion 221 in a direction facing the panel portion 300. Therefore, the first support end portion 221 may allow the boss portion 320 to be fixedly locked in the rotation direction when the panel portion 300 rotates, and the second support end portion 222 may be in contact with the boss portion 320 to form a support structure.

Therefore, the boss portion 320 of the panel portion 300 may include a first insertion end portion 321 extending to be inserted into the mounting hole 210 and formed to be curved, and a second insertion end portion 322 connected to an extended end portion of the first insertion end portion 321 to form a space together with the first insertion end portion 321 between the first insertion end portion 321 and the second insertion end portion 322.

As shown in FIG. 4, the boss portion 320 includes the first insertion end portion 321 and the second insertion end portion 322, and the first insertion end portion 321 extends in a direction which is inserted into the mounting hole 210 from the panel portion 300 and formed to be curved or bent to form a space therein. The second insertion end portion 322 may be formed at the extended end portion of the first insertion end portion 321 to form the space together with the first insertion end portion 321, and thus the locking protrusion 220 may be inserted into the corresponding space.

Therefore, when the panel portion 300 is rotated in a state in which the boss portion 320 is inserted into the mounting hole 210 of the pocket portion 200, the first insertion end portion 321 of the boss portion 320 is in contact with the first support end portion 221 of the locking protrusion 220 of the pocket portion 200, and thus the rotation thereof is restricted, and the first insertion end portion 321 is in contact with the second support end portion 222 of the locking protrusion 220, and thus the panel portion 300 cannot be moved in a removal direction thereof. In other words, the boss portion 320 of the panel portion 300 is in contact with the first support end portion 221 of the locking protrusion 220 and thus the rotation thereof may be restricted, and the second insertion end portion 322 is in contact with the second support end portion 222 of the locking protrusion 220, and thus the movement of the panel portion 300 in the direction which is removed from the pocket portion 200 may be restricted to maintain the locking state.

Meanwhile, a third insertion end portion 323 inserted into the mounting hole 210 and connected to the plurality of first insertion end portions 321 may be formed on the panel portion 300.

As shown in FIG. 4, a plurality of panel portions 300 include a plurality of first insertion end portions 321 configured in a circumferential direction of the mounting hole 210, and each of the first insertion end portions 321 is connected to the third insertion end portion 323, securing the durability and rigidity of each of the first insertion end portions 321.

The third insertion end portion 323 may be formed in an annular shape according to a shape of the mounting hole 210, and a thickness thereof may be determined according to the required rigidity of the first insertion end portion 321.

Furthermore, a reinforcement rib 324 connected to two or more of the first insertion end portion 321, the second insertion end portion 322, and the third insertion end portion 323 may be formed on the panel portion 300.

The reinforcement rib 324 may be formed in a shape extending outwardly from the mounting hole 210 to be connected to the first insertion end portion 321, the second insertion end portion 322, and the third insertion end portion 323 and may be formed of a plurality of ribs to additionally secure rigidity in a state of being connected to the first insertion end portion 321, the second insertion end portion 322, and the third insertion end portion 323.

Therefore, by increasing the rigidity of the boss portion 320 itself in the state in which the boss portion 320 of the panel portion 300 is connected to be locked to the locking protrusion 220 of the pocket portion 200, the panel portion 300 can maintain a state of being robustly fastened to the pocket portion 200 even when an external impact is applied.

Meanwhile, because the first insertion end portion 321 extending in a direction which is inserted into the mounting hole 210 is formed to have a larger length than the second support end portion 222 extending in a direction facing the panel portion 300, the second insertion end portion 322 and the second support end portion 222 may be spaced from each other at a predetermined interval.

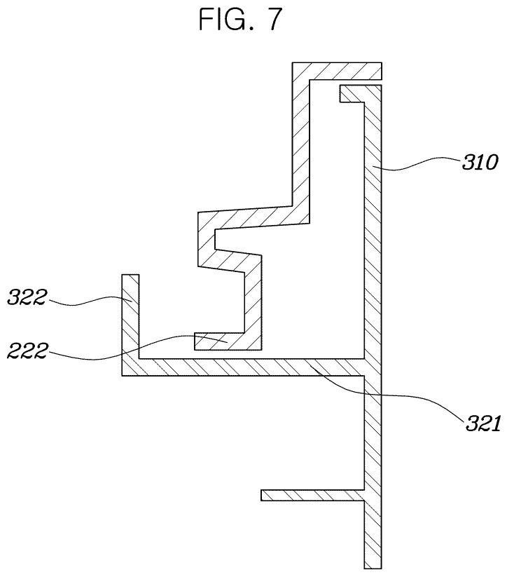

Referring to FIG. 7, because the boss portion 320 is formed to extend in a direction in which the panel portion 300 is mounted more than the locking protrusion 220 of the pocket portion 200, it is easy to mount the panel portion 300 on the pocket portion 200.

Furthermore, by forming the fastening structure of an upper locking portion 230 and a lower locking portion 240 of the pocket portion 200 and an upper fastening portion 330 and a lower fastening portion 340 of the panel portion 300, which will be described below, it is possible to secure the robust fastening state of the panel portion 300 through a linear mounting structure and a rotation direction mounting structure of the mounting hole 210.

The upper locking portion 230 and the lower locking portion 240 may be spaced from the mounting hole 210 and respectively formed on upper and lower portions of the pocket portion 200, and the upper fastening portion 330 detachably fastened to the upper locking portion 230 and the lower fastening portion 340 detachably fastened to the lower locking portion 240 may be formed on the panel portion 300.

Referring to FIGS. 2, 4, 7, and 8, the upper locking portion 230 may be formed on edge portions of both end portions at the top portion of the pocket portion 200, and the lower locking portion 240 may be formed on edge portions of both end portions at the bottom thereof. Therefore, the panel portion 300 can minimize a lifting phenomenon of the edge portion when mounted on the pocket portion 200.

Therefore, by forming the upper fastening portion 330 matching the upper locking portion 230 and the lower fastening portion 340 matching the lower locking portion 240 on the panel portion 300, an upper portion of the panel portion 300 may be fixed to the pocket portion 200 when the upper locking portion 230 is fastened to the upper fastening portion 330, and a lower portion of the panel portion 300 may be fixed to the pocket portion 200 when the lower locking portion 240 is fastened to the lower fastening portion 340.

Furthermore, because a separate sub-support portion 250 may be further formed along the periphery of the pocket portion 200, the panel portion 300 may be accommodated on the sub-support portion 250, stabilizing the fixed state.

As described above, the upper fastening portion 330 and the lower fastening portion 340 of the panel portion 300 include a structure which is linearly fastened to the upper locking portion 230 and the lower locking portion 240 of the pocket portion 200 in a direction which is inserted into the mounting hole 210.

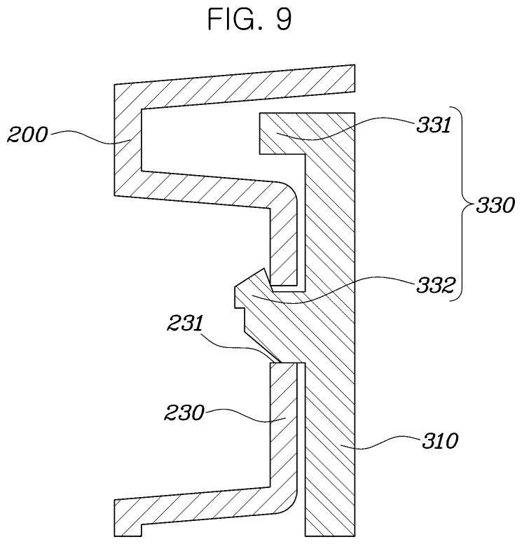

As shown in FIG. 9, the upper locking portion 230 may be formed with a first locking hole 231 and protrude to allow the upper portion of the panel portion 300 to be accommodated thereon and the upper fastening portion 330 of the panel portion 300 is locked by being inserted into the first locking hole 231.

Furthermore, the upper fastening portion 330 may include a first seating portion 331 protruding to be supported on an upper surface of the upper locking portion 230, and a first connection portion 332 inserted to be locked to the first locking hole 231.

As described above, as the upper locking portion 230 of the pocket portion 200 is formed to protrude, when the panel portion 300 moves in a direction which is mounted on the pocket portion 200, the first seating portion 331 is accommodated on the upper surface of the upper locking portion 230. Therefore, the panel portion 300 prevents warpage upward, and the upper fastening portion 330 has a support structure with respect to the upper locking portion 230.

At the same time, as the first connection portion 332 of the panel portion 300 is locked by being inserted into the first locking hole 231 of the pocket portion 200, the panel portion 300 may become a state of being fixed to the pocket portion 200. Therefore, it is possible to maintain the state in which the upper portion of the panel portion 300 is connected to the pocket portion 200.

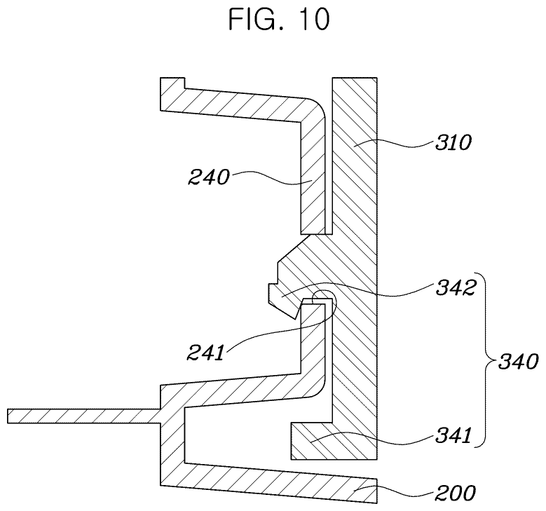

As shown in FIG. 10, the lower locking portion 240 may be formed with a second locking hole 241 and protrude to allow the lower portion of the panel portion 300 to be accommodated on the lower locking portion 240 and the lower fastening portion 340 of the panel portion 300 is locked by being inserted into the second locking hole 241.

Furthermore, the lower fastening portion 340 may include a second seating portion 341 protruding to be supported on a lower surface of the lower locking portion 240, and a second connection portion 342 inserted to be locked to the second locking hole 241.

As described above, as the lower locking portion 240 of the pocket portion 200 is formed to protrude, when the panel portion 300 moves in a direction which is mounted on the pocket portion 200, the second seating portion 341 is accommodated on the lower surface of the lower locking portion 240. Therefore, the panel portion 300 prevents warpage downward, and the lower fastening portion 340 has a support structure with respect to the lower locking portion 240.

At the same time, as the second connection portion 342 of the panel portion 300 is locked by being inserted into the second locking hole 241 of the pocket portion 200, the panel portion 300 may become a state of being fixed to the pocket portion 200. Therefore, it is possible to maintain the state in which the lower portion of the panel portion 300 is connected to the pocket portion 200.

Therefore, the panel portion 300 may be mounted on or removed from the pocket portion 200, and the installation or removal according to the above structure may be performed as follows.

The upper locking portion 230 and the upper fastening portion 330 and the lower locking portion 240 and the lower fastening portion 340 may be positioned to be fastened by being matched mutually in the state of being rotated and locked after being inserted into the mounting hole 210 of the pocket portion 200.

In other words, when the panel portion 300 is positioned to match the pocket portion 200, the upper locking portion 230 and the upper fastening portion 330 are matched, and the lower locking portion 240 and the lower fastening portion 340 are matched, and when the panel portion 300 is tilted with respect to the pocket portion 200 and disposed to be misaligned, the upper locking portion 230 and the upper fastening portion 330 are not matched, and the lower locking portion 240 and the lower fastening portion 340 are not matched, but the boss portion 320 of the panel portion 300 may become a state which may be inserted into the mounting hole 210 of the pocket portion 200 and connected through the rotation operation.

As described above, the linear mounting structure and rotation direction mounting structure of the panel portion 300 with respect to the mounting hole 210 of the pocket portion 200 may be separated, securing the robust fastening state of the panel portion 300.

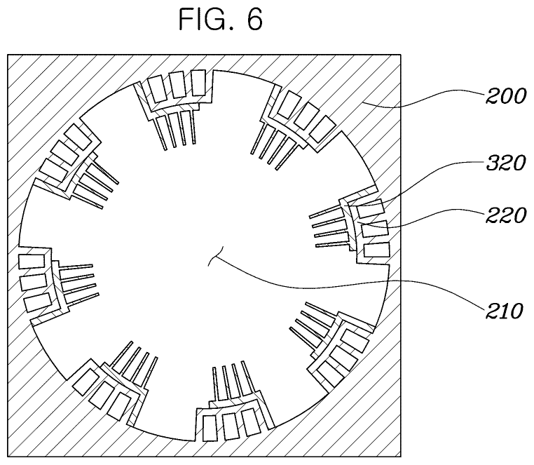

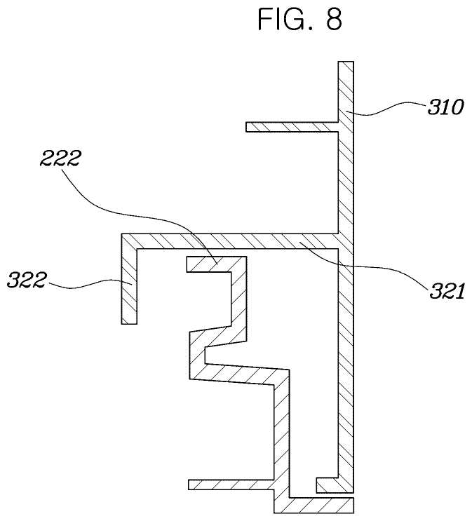

As shown in FIG. 6, FIG. 7, FIG. 8, FIG. 9 and FIG. 10, when the panel portion 300 is fastened to the pocket portion 200, the panel portion 300 is rotated in the state in which the boss portion 320 of the panel portion 300 is inserted into the mounting hole 210 of the pocket portion 200 so that the boss portion 320 is locked to the locking protrusion 220, and the upper locking portion 230 and the upper fastening portion 330, and the lower locking portion 240 and the lower fastening portion 340 may be fixed by being sequentially fastened therebetween.

In other words, as shown in FIG. 6, after the boss portion 320 of the panel portion 300 is inserted into the mounting hole 210 of the pocket portion 200, the panel 310 is rotated so that the boss portion 320 is locked to the locking protrusion 220.

In the instant case, as shown in FIGS. 7 and 8, the second insertion end portion 322 of the boss portion 320 of the panel portion 300 is spaced from the second support end portion 222 of the locking protrusion 220 of the pocket portion 200 at a predetermined interval. Such an interval allows the upper fastening portion 330 to be inserted into the upper locking portion 230 and the lower fastening portion 340 to be inserted into the lower locking portion 240.

Here, as shown in FIG. 9 and FIG. 10, the upper fastening portion 330 may be connected to the upper locking portion 230, and the lower fastening portion 340 may be connected to the lower locking portion 240 to fix panel portion 300 to the pocket portion 200. In the instant case, the upper fastening portion 330 and the upper locking portion 230 or the lower fastening portion 340 and the lower locking portion 240 may be fastened sequentially, and a connection sequence is irrelevant.

As described above, a robust fixing structure may be implemented by allowing the boss portion 320 and the locking protrusion 220 to be fixed primarily through the rotation of the panel portion 300 in the state in which the panel portion 300 matches the mounting hole 210 of the pocket portion 200 and linearly connecting and secondarily fixing the upper fastening portion 330 and the upper locking portion 230 to the lower fastening portion 340 and the lower locking portion 240.

Therefore, even in case of collision, the panel portion 300 is prevented from being removed from the pocket portion 200.

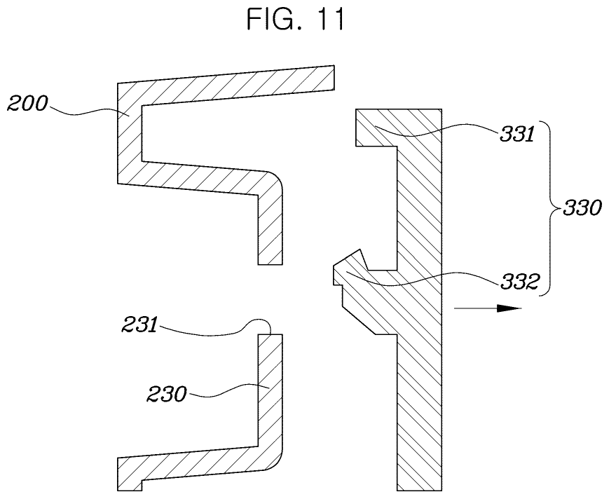

Meanwhile, as shown in FIGS. 11 to 15, when the panel portion 300 is removed from the pocket portion 200, the boss portion 320 may be switched to a removable state by rotating the panel portion 300 after the upper fastening portion 330 and the lower fastening portion 340 of the panel portion 300 are sequentially removed to allow the boss portion 320 to be removed from the locking protrusion 220.

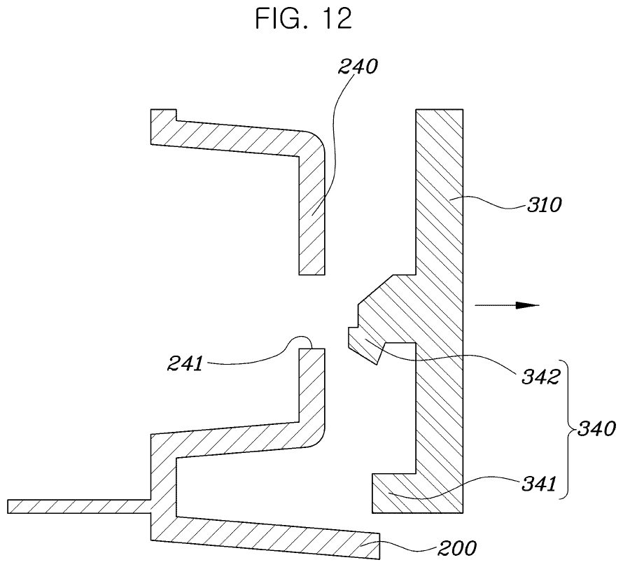

In other words, as shown in FIG. 11 and FIG. 12, the upper fastening portion 330 is removed from the upper locking portion 230, and the lower fastening portion 340 is removed from the lower locking portion 240.

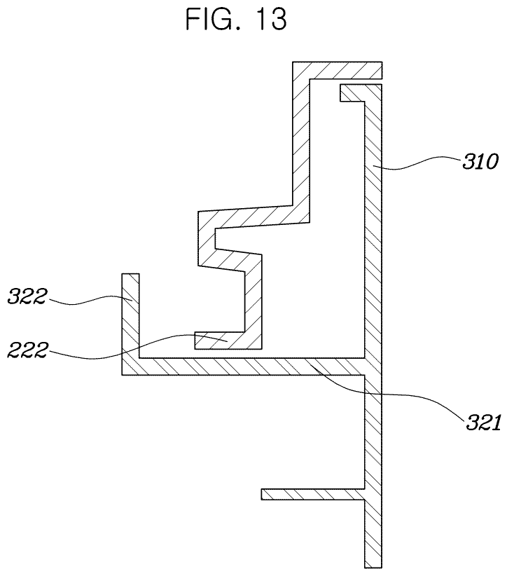

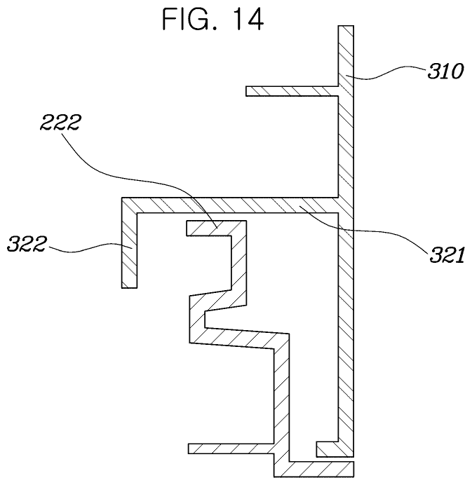

In the instant case, as shown in FIG. 13, because the insertion end portion 322 of the boss portion 320 of the panel portion 300 is spaced from the second support end portion 222 of the locking protrusion 220 of the pocket portion 200 at an interval, the panel portion 300 may move in a direction away from the pocket portion 200. Therefore, as shown in FIGS. 13 and 14, the panel portion 300 may be moved from the pocket portion 200 and switched to a rotatable state.

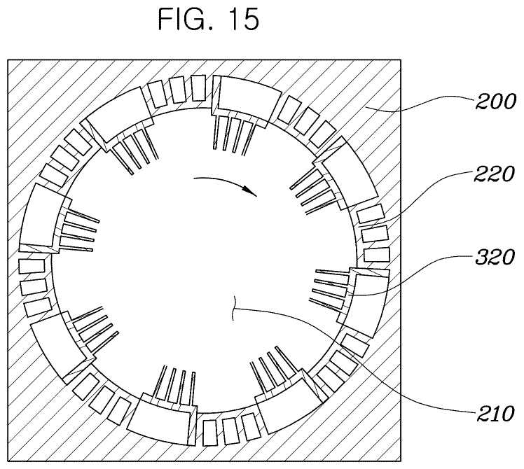

Here, as shown in FIG. 15, the panel portion 300 may be rotated so that the boss portion 320 may be removed from the locking protrusion 220, and the panel portion 300 may be removed from the pocket portion 200.

According to the customizing apparatus including the above configuration, it is possible to variously change the design elements according to the user's needs, save the design change cost, secure the convenience for installation and removal, and secure stability by securing collision rigidity.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A customizing apparatus comprising:
a wall portion forming an internal wall and an external wall of a mobility and including a predetermined area;
a pocket portion provided in plural in the predetermined area of the wall portion, including a mounting hole on a center portion of the pocket portion, and including a plurality of locking protrusions along a periphery of the mounting hole; and
a panel portion including a panel and a plurality of boss portions extending from the panel and configured to be inserted into the mounting hole,
wherein the boss portions are positioned at a side of the locking protrusions when inserted into the mounting hole, and the boss portions are fixedly locked to the locking protrusions in a rotation direction when the panel is rotated.

2. The customizing apparatus of claim 1,
wherein the plurality of locking protrusions of the pocket portion is spaced from each other at equal intervals in the mounting hole in a circumferential direction of the mounting hole, and
wherein the boss portions are formed on the panel portion in a same number as the locking protrusions and to be spaced from each other at a same interval as the locking protrusions.

3. The customizing apparatus of claim 1, wherein each locking protrusion of the pocket portion includes a first support end portion extending toward the center portion of the mounting hole, and a second support end portion protruding from the first support end portion in a direction facing the panel portion.

4. The customizing apparatus of claim 3, wherein each boss portion of the panel portion includes a first insertion end portion extending to be inserted into the mounting hole and formed to be curved, and a second insertion end portion connected to an extending end portion of the first insertion end portion to form a space together with the first insertion end portion.

5. The customizing apparatus of claim 4, further including a third insertion end portion formed on the panel portion, inserted into the mounting hole and connected to a plurality of first insertion end portions.

6. The customizing apparatus of claim 5, further including a reinforcement rib formed on the panel portion and connected to two or more of the first insertion end portion, the second insertion end portion, and the third insertion end portion.

7. The customizing apparatus of claim 4, wherein the first insertion end portion extending in a direction which is inserted into the mounting has a larger length than the second support end portion in a direction which faces the panel portion, and the second insertion end portion and the second support end portion are spaced from each other at a predetermined interval.

8. The customizing apparatus of claim 4, wherein when the panel portion is rotated in a state in which the boss portions are inserted into the mounting hole of the pocket portion, the first insertion end portion of the boss portions is in contact with the first support end portion and the second insertion end portion of the boss portions is in contact with the second support end portion of each locking protrusion.

9. The customizing apparatus of claim 1,
wherein the pocket portion includes an upper locking portion and a lower locking portion spaced from the mounting hole and formed on an upper portion and a lower portion of the pocket portion, respectively, and
wherein the panel portion includes:
an upper fastening portion detachably fastened to the upper locking portion; and
a lower fastening portion detachable fastened to the lower locking portion.

10. The customizing apparatus of claim 9,
wherein the upper locking portion includes a first locking hole and protrudes to allow an upper portion of the panel portion to be accommodated on the upper locking portion and
wherein the upper fastening portion of the panel portion is locked by being inserted into the first locking hole.

11. The customizing apparatus of claim 10, wherein the upper fastening portion includes:
a first seating portion protruding to be supported on an upper surface of the upper locking portion; and
a first connection portion inserted to be locked to the first locking hole.

12. The customizing apparatus of claim 9,
wherein the lower locking portion includes a second locking hole and protrudes to allow a lower portion of the panel portion to be accommodated on the lower locking portion, and
wherein the lower fastening portion of the panel portion is locked by being inserted into the second locking hole.

13. The customizing apparatus of claim 12, wherein the lower fastening portion includes:
a second seating portion protruding to be supported on a lower surface of the lower locking portion; and
a second connection portion inserted to be locked to the second locking hole.

14. The customizing apparatus of claim 9, wherein the upper locking portion and the upper fastening portion, and the lower locking portion and the lower fastening portion are positioned to be fastened by being matched mutually in a state in which the boss portions of the panel portion are locked by being rotated after inserted into the mounting hole of the pocket portion.

15. The customizing apparatus of claim 14, wherein, in a situation that the panel portion is mounted on the pocket portion and the panel portion is rotated in a state in which the boss portions of the panel portion are inserted into the mounting hole of the pocket portion, the boss portions are locked to the locking protrusions, and the upper locking portion and the upper fastening portion, and the lower locking portion and the lower fastening portion are fixed by being sequentially fastened therebetween.

16. The customizing apparatus of claim 14, wherein, in a situation that the panel portion is removed from the pocket portion, the boss portions are switched to a removable state when the panel portion is rotated after the upper fastening portion and the lower fastening portion of the panel portion are sequentially removed to allow the boss portions to be removed from the locking protrusions.
